(19) United States
(12) Patent Application Publication
(10) Pub. No.: US 2010/0054148 A1
(43) Pub. Date: Mar. 4, 2010

(54) DATA ASSOCIATION SYSTEM, DATA ASSOCIATION METHOD AND DATA ASSOCIATION PROGRAM

(75) Inventors: Masahiko Murakami, Kawasaki (JP); Satoshi Okuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/615,715

(22) Filed: Nov. 10, 2009

Related U.S. Application Data
(63) Continuation of application No. PCT/JP2007/061133, filed on May 31, 2007.

(51) Int. Cl. H04L 12/26; H04L 12/66

(52) U.S. Cl. 370/252; 370/352

(57) ABSTRACT

A data association system includes: a communication monitoring unit that records communication status data; a communication data acquiring unit that acquires first communication data that the communication terminal exchanges during the communication indicated by the communication status data and records the first communication data; a data communication unit that makes second communication data accessible to the both users through communication different from the communication of the first communication data; and an association unit that specifies, among in-progress communications indicated by the communication status data, communication held by the same users as the both users in the communication of the second communication data and makes the first communication data recorded in a state of being associated with the specified communication data accessible to the both users.

### CROSS-REFERENCE TO RELATED APPLICATION

This application is based upon and claims the benefit of priority of the prior International Patent Application No. PCT/JP2007/061133, filed on May 31, 2007, the entire contents of which are incorporated herein by reference.

### FIELD

The embodiments discussed herein are related to a data association system, a data association method, and a data association program that efficiently associate contexts with a file, for example, associate, when a user sends or receives a file in the middle of communication using a communication terminal, information (contexts) indicating the circumstances under which the file is sent or received with the file.

### BACKGROUND

Due to the wide spread use of IP networks and softphones (the function of a telephone implemented by a software program on a computer such as a PC), it has become possible to send and receive files to/from the party on the other end during a phone call using the phone. Thus, one user receives files with regard to a variety of businesses from a variety of people as a result of having repeated phone calls. In such a case, it is difficult to recall when referring to the received files at a later date (even if explanations for the received files were given during the phone calls) from whom and for what business each of the files was received and what kind of work needs to be done with regard to the file.

In order not to forget about the circumstances under which a file was received, for example, the following measurements have been taken. First, a user who receives a file during a phone call takes notes about the file. Or, instead of sending a file during a phone call, a file is separately sent by being attached to an e-mail in which the business is described. For example, a communication terminal having phone-answering and e-mail receiving functions as well as a function of reproducing video attached to a received e-mail subsequently after reproducing a recorded message has been disclosed (see Japanese Laid-open Patent Publication No. 2006-210999, for example).

In the above conventional technique, however, a function of associating the message recorded using the phone-answering function and the video attached to the received e-mail with each other is not available. Thus, the above conventional technique requires a user to put extra time and effort into recording information indicating the circumstances under which the file was received. For example, taking notes during a phone call is troublesome and it requires putting extra time and effort. Also, when sending an e-mail with an attached file, a user is required to put time and effort into changing the file sending method or into typing the business in the e-mail. In a case where pieces of information related to each other are exchanged in the form of different types of communication data such as a phone call and sending of a file as described above, a problem is to effectively associate those different types of communication data with each other.

It is considered that occasions of sending and receiving related pieces of information in the form of different types of communication data, such as receiving a file during a phone call, will increase as IP phones and optical networks further proliferate. Accordingly, it is considered that the problem would become more serious.

### SUMMARY

According to one aspect of the present invention, a data association system includes: a communication monitoring unit that records, in a recording unit, communication status data containing data indicating a communication status of communication performed by a communication terminal and data for specifying at least one of both users in the communication; a communication data acquiring unit that acquires first communication data that the communication terminal exchanges during the communication indicated by the communication status data and records the first communication data in the recording unit in a state where the first communication data is associated with the communication status data of the communication; a data communication unit that makes second communication data accessible to the both users through communication different from the communication of the first communication data; and an association unit that specifies, among in-progress communications indicated by the communication status data, communication held by the same users as the both users in the communication of the second communication data and makes the first communication data recorded in a state of being associated with the specified communication data accessible to the both users by associating the first communication data with the second communication data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a functional block diagram illustrating the configuration of an entire system including a data association system according to Embodiment 1.

FIG. 2A is a diagram illustrating an example of a call status table.

FIG. 2B is a diagram illustrating an example of a sharing space table.

FIG. 2C is a diagram illustrating an example of a party table.

FIG. 3 is a flowchart illustrating an operation example of a communication monitoring unit and a sharing space generation unit in Embodiment 1.

FIG. 4 is a flowchart illustrating an operation example of a call data acquiring unit.

FIG. 5 is a flowchart illustrating a series of processes of associating a file and call data with each other.

FIG. 6A is a diagram illustrating an example of a screen displayed on a data communication terminal 15a.

FIG. 6B is a diagram illustrating an example of a screen displayed on the data communication terminal 15a after addition of a file.

FIG. 7 is a functional block diagram illustrating the configuration of an entire system including a data association system according to Embodiment 2.

FIG. 8 is a diagram illustrating an example of a call status table in Embodiment 2.

FIG. 9 is a flowchart illustrating an example of a series of processes in which the data association system according to Embodiment 2 receives a file and records the file in a state where the file is associated with call data.

FIG. 10 is a functional block diagram illustrating the configuration of an entire system including a data association system according to Embodiment 3.

FIG. 11 is a flowchart illustrating an example of a series of processes in which the data association system according to Embodiment 3 receives an instruction to send a file and sends the file in a state of being associated with call data.

### DESCRIPTION OF EMBODIMENTS

According to one aspect of the present invention, a data association system includes: a communication monitoring unit that records, in a recording unit, communication status data including data indicating a communication status of communication performed by a communication terminal and data for specifying other user in communication with whom a user of the communication terminal is communicating; a communication data acquiring unit that acquires first communication data sent or received by the communication terminal in the communication indicated by the communication status data, and records, in the recording unit, the first communication data in a state of being associated with the communication status data of the communication; a data communication unit that communicates second communication data, which is data different from the first communication data, with the communication terminals used by the plurality of users or with other terminals used by the plurality of users; and at least one of a reception data association unit and a send data association unit. The reception data association unit specifies a sender and a receiver of second communication data received by the data communication unit, compares the sender and the receiver with the communication status data to extract, from the second communication data, data sent to the user of the communication terminal from other user in communication as reception data, associates the extracted reception data with first communication data of the communication performed by the communication terminal, and records the extracted reception data in the recording unit in a state of being accessible to the user of the communication terminal, and the send data association unit specifies a sender and a receiver of second communication data to be sent by the data communication unit, compares the sender and the receiver with the communication status data to extract, from the second communication data to be sent by the data communication unit, data to be sent from the user of the communication terminal to other user in communication as send data, and causes the data communication unit to send the extracted reception data in a state of being associated with first communication data of the communication performed by the communication terminal.

The communication monitoring unit records, in the recording unit, the data indicating the communication status of communication between a plurality of users including the user of the communication terminal to be monitored and the data for specifying the other user in the communication as the communication status data. Thus, the other user with whom the user of the communication terminal is communicating is specified. Further, the communication data acquiring unit records, in the recording unit, the first communication data exchanged during the communication performed by the communication terminal to be monitored in a state where the first communication data is associated with the communication status data of the communication.

As a result, the reception data association unit may extract reception data sent from the other user to the user of the communication terminal during the communication by comparing the sender and the recipient of second communication data received by the data communication unit with the communication status data. Then, the reception data association unit records the extracted reception data in the recording unit in a state where the second communication data is associated with the first communication data of the communication performed by the communication terminal and they are accessible to the user of the communication terminal. Thus, when the user of the communication terminal makes reference to the reception data sent from the other user, he/she may also make reference to the first communication data associated with the reception data. In other words, the user of the communication terminal may make reference to the reception data (the second communication data) as well as the first communication data of the communication that the user had with the other user when the user received the reception data.

In contrast, the send data association unit may extract send data to be sent from the user of the communication terminal to the other user during the communication by comparing the communication status data with the sender and the recipient of the second communication data to be sent by the data communication unit. The send data association unit causes the data communication unit to send the extracted send data in a state where the extracted send data is associated with the first communication data of the communication. Thus, the send data associated with the first communication data is sent to the other user. When making reference to the sent send data, the other user may also make reference to the first communication data associated with the send data. As a result, the other user may make reference to the send data (the second communication data) as well as the first communication data of the communication at the time when the send data was sent.

As described above, without requiring both the user of the communication terminal and the other user to put extra time and effort, with the reception data sent to the user of the communication terminal from the other user or the send data sent from the user of the communication terminal to the other user, the first communication data of the communication is automatically associated. Consequently, in communication where pieces of information relate to each other are sent in the form of different types of communication data such as the first communication data and the second communication data, it is possible to efficiently associate the respectively-exchanged pieces of the communication data with each other and make them readily referable by the users.

According to one aspect of the present invention, the data association system may have such a configuration that the communication terminal includes at least the communication monitoring unit, the communication data acquiring unit, the data communication unit and the send data association unit, and further includes a user interface unit that receives an instruction to send second communication data inputted by the user of the communication terminal. The send data association unit may specify a receiver of second communication data indicated by the send instruction received by the user interface unit, and when the receiver is other user in the communication performed by the communication terminal indicated by the communication status data recorded in the recording unit, the send data association unit may cause the data communication unit to send the second communication data as send data in a state of being associated with first communication data of the communication performed by the communication terminal.

By this configuration, a user of the communication terminal that includes the data association system may input, for example, an instruction to send data to the other user during communication using the communication terminal. To the other user in the communication performed by the communication terminal, the first communication data exchanged during the communication is associated with the send data instructed by the user of the communication terminal by the send data association unit and is sent. Thus, the user of the communication terminal may send desired send data to the other user in the communication using the communication terminal, for example. At that time, the send data is sent in a state of being associated with the first communication data exchanged during the communication. As a result, the other user may access the send data (the second communication data) as well as the first communication data exchanged during the communication at the time when the send data was sent. Therefore, without putting time and effort into, for example, taking notes about the send data received during the communication, the other user may recall, for example, the circumstances under which the communication took place from the first communication data at the time when the send data was sent.

In the data association system according to one aspect of the present invention, the communication terminal may include at least the communication monitoring unit, the communication data acquiring unit, the data communication unit and the reception data association unit, and further include a user interface unit for allowing the user of the communication terminal to access data recorded in the recording unit. The reception data association unit may specify a sender of second communication data received by the data communication unit, and when the sender is other user in the communication performed by the communication terminal indicated by the communication status data recorded in the recording unit, the reception data association unit may record in the recording unit the second communication data as reception data in a state of being associated with first communication data of the communication performed by the communication terminal and accessible to the user of the communication terminal through the user interface unit.

By this configuration, during communication performed by the communication terminal, when the user of the communication terminal receives reception data sent from the other user in the communication, the reception data association unit records the reception data in a state where the reception data is associated with the first communication data exchanged during the communication. At that time, the reception data (the second communication data) is recorded in the recording unit in a stated of being accessible through the user interface unit. Thus, when accessing through the user interface unit the reception data received from the other user, the user of the communication terminal may also access the first communication data exchanged during the communication at the time when the reception data was received. Therefore, without putting time and effort into, for example, taking notes about the reception data received during the communication, the user may recall, for example, the circumstances under which the communication took place from the first communication data at the time when the reception data was received.

According to one aspect of the present invention, the data association system may further includes a server connected to a communication control device that controls communication among a plurality of communication terminals, the server including at least the communication monitoring unit, the communication data acquiring unit, the data communication unit and the reception data association unit. The communication monitoring unit may detect, through the communication control device, communication between at least two users among users of the plurality of communication terminals and records in the recording unit data indicating a communication status of the detected communication and data for specifying the both users in the communication, and when a sender and a receiver of second communication data received by the data communication unit are the both users of the communication indicated by the communication status data recorded in the recording unit, the reception data association unit may record in the recording unit the second communication data as reception data in a state of being associated with first communication data of the communication in such a manner that the second communication data is accessible to the both users.

In the above configuration, the communication monitoring unit detects communications taking place among a plurality of communication terminals and controlled by the communication control device and records the communication status data indicating the communication status of each detected communication and both users in each communication. Thus, the status of each communication taking place among the plurality of communication terminals and both users in each communication are recorded in the recording unit as the communication status data. Therefore, the reception data association unit may specify both users in each communication taking place among the plurality of communication terminals. Consequently, when communication takes place between at least two users and the data communication unit receives reception data sent from one user to the other user, the reception data association unit may record the reception data in a state where the reception data is associated with the first communication data exchanged during the communication. At that time, the reception data (the second communication data) is recorded in the recording unit in a state of being accessible to the both users in the communication. Thus, when accessing the reception data sent from one user to the other user during the communication, the both users may also access the first communication data exchanged during the communication at the time when the reception data was sent. Thus, without putting time and effort into, for example, taking notes about the reception data received during the communication, the both users may recall, for example, the circumstances under which the communication took place from the associated first communication data.

In the data association system according to one aspect of the present invention, the send data association unit and the reception data association unit may associate the first communication data with the send data or the reception data by compressing the first communication data together with the send data or the reception data to generate a single file.

Due to this configuration, the first communication data and the second communication data (the send data or the reception data) are treated as a single file. Since a user who accesses the file may also directly access the first communication data, he/she may confirm the first communication data easily.

In the data association system according to one aspect of the present invention, the send data association unit and the reception data association unit may associate the first communication data with the send data or the reception data by writing in or adding to the send data or the reception data information for accessing the first communication data.

Due to this configuration, the size of the second communication data (the send data or the reception data) may be reduced. Further, in this case, the point in time at which the send data is sent or the point in time at which the reception data is received does not have to be the same as the point in time at which the first communication data is recorded. The point in time at which the send data is sent or the point in time at which the reception data is received does not limit the range of the first communication data to be associated.

In the data association system according to one aspect of the present invention, the send data association unit and the reception data association unit may associate the first communication data with the send data or the reception data by generating association data for recording data indicating a recoded location of the first communication data in a state of being associated with the send data or the reception data.

Due to this configuration, the first communication data and the second communication data (the send data or the reception data) may be associated with each other in a state where they are recorded at different locations.

In the data association system according to one aspect of the present invention, the send data association unit and the reception data association unit may determine a range of first communication data to be associated with the send data or the reception data relative to a point in time when the data communication unit sends the send data or the data communication unit receives the reception data.

Due to this configuration, it is possible to narrow down the portion of the first communication data to be associated to a portion that is highly likely to be required. As a result, its size may be limited.

In the data association system according to one aspect of the present invention, the sending data association unit and the receiving data association unit may detect an instruction signal inputted by the user of the communication terminal or by other user and determine a range of first communication data to be associated with the sending data or with the receiving data on the basis of the instruction signal.

By determining the range of the first communication data to be associated with the second communication data (the send data or the reception data) on the basis of the instruction signal inputted by the user, it is possible to associate the portion of the first communication data the user desires with the send data or the reception data. Further, it is possible to limit the size of the first communication data to be associated with the send data or the reception data.

In the data association system according to one aspect of the present invention, the first communication data may be voice data that is sent and received in the communication performed by the communication terminal, and the send data association unit and the reception data association unit may detect a silent pause in the first communication data and determine a range of the first communication data to be associated with the send data or the reception data relative to the silent pause.

In voice communications, in many cases, a silent pause may be a point at which a topic is changed. Thus, by determining the range of the first communication data to be associated with the second communication data (the send data or the reception data) relative to the silent pause, portion of the first communication data highly likely to contain an appropriate topic may be associated with the send data or the reception data. Further, it is possible to limit the size of the first communication data to be associated with the send data or the reception data.

According to one aspect of the present invention, a data association method performed by a computer includes: a communication monitoring unit included in the computer, in a recording unit included in the computer, communication status data including data indicating a communication status of communication performed by a communication terminal and data for specifying other user in communication with whom a user of the communication terminal is communicating; a communication data acquiring unit included in the computer acquiring first communication data sent and received by the communication terminal in the communication indicated by the communication status data to record in the recording unit the first communication data in a state of being associated with the communication status data of the communication; a data communication unit included in the computer communicating second communication data, which is data other than the first communication data, with the communication terminals used by the plurality of users or with other terminals used by the plurality of users; and at least one of associating reception data and associating send data. In the associating reception data, a reception data association unit included in the computer specifies a sender and a receiver of second communication data received by the data communication unit, compares the sender and the receiver with the communication status data to extract, from the second communication data, data sent to the user of the communication terminal from other user in communication as reception data, and records the extracted reception data in the recording unit in a state of being associated with first communication data of the communication performed by the communication terminal and being accessible to the user of the communication terminal, and in the associating send data, a send data association unit included in the computer specifies a sender and a receiver of second communication data to be sent by the data communication unit, compares the sender and the receiver with the communication status data to extract, from the second communication data to be sent by the data communication unit, data to be sent from the user of the communication terminal to other user in communication as send data, and causes the data communication unit to send the extracted reception data in a state of being associated with first communication data of the communication performed by the communication terminal.

According to one aspect of the present invention, a data association program causing a computer to execute a data association operation, the computer executes: a communication monitoring process in which communication status data including data indicating a communication status of communication performed by a communication terminal and data for specifying other user in the communication with whom a user of the communication terminal is communicating is recorded in a recording unit included in the computer; a communication data acquiring process in which first communication data sent and received by the communication terminal in the communication indicated by the communication status data is acquired to record the first communication data in the recording unit in a state of being associated with the communication status data of the communication; a data communication process in which second communication data, which is data other than the first communication data, is communicated with the communication terminals used by the plurality of users or with other terminals used by the plurality of users; and at least one of a reception data association process and a send data association process. The reception data association process is a process in which a sender and a receiver of second communication data received by the data communication unit are specified, the sender and the receiver are compared with the communication status data to extract, from the second communication data, data sent to the user of the communication terminal from other user in communication as reception data, and the extracted reception data is recorded in the recording unit in a state of being associated with first communication data of the communication performed by the communication terminal and being accessible to the user of the communication terminal, and the send data association process is a process in which a sender and a receiver of second communication data to be sent by the data communication unit are specified, the sender and the receiver are compared with the communication status data to extract, from the second communication data to be sent by the data communication unit, data to be sent from the user of the communication terminal to other user in communication as send data, and the data communication unit is caused to send the extracted reception data in a state of being associated with first communication data of the communication performed by the communication terminal.

According to the present invention, in communication where pieces of information related to each other are respectively exchanged in the form of different types of communication data, it is possible to efficiently associate the respectively-exchanged different types of communication data with each other and make them readily referable by a user, without requiring the user to put extra time and effort.

Hereinafter, more specific embodiments of the present invention will be described in detail with reference to the drawings.

### Embodiment 1

### System Configuration

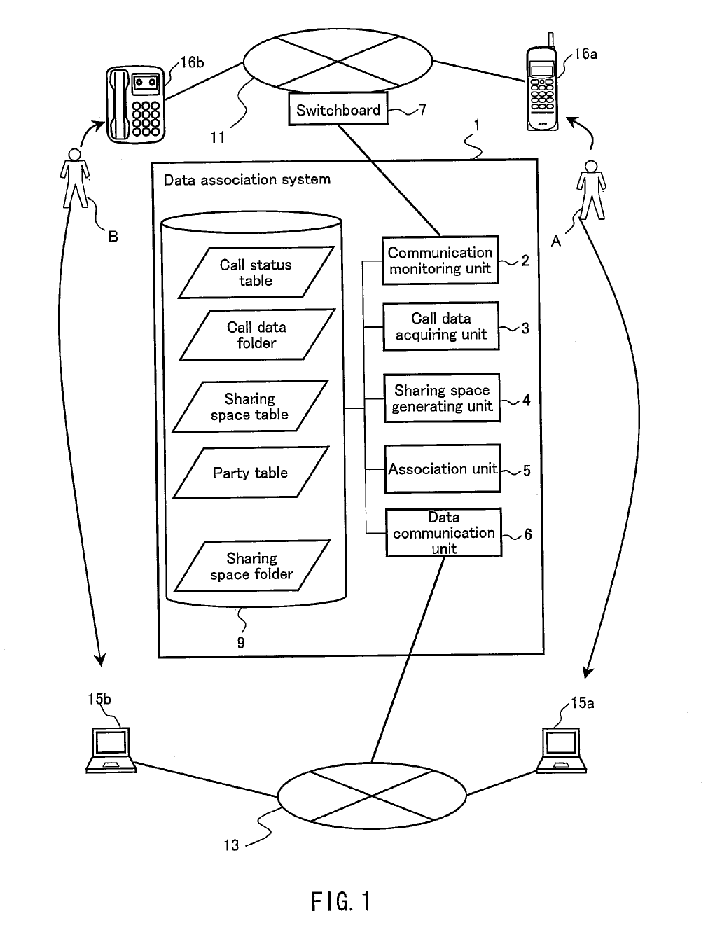

FIG. 1 is a functional block diagram illustrating the configuration of an entire system including a data association system according to the present embodiment. A data association system 1 is connected to a switchboard 7 in a phone network 11 and to the Internet 13. A plurality of phone terminals including phone terminals 16a and 16b are connected to the phone network 11. For example, the phone terminal 16a is connected to the phone terminal 16b, the party on the other end, through the switchboard 7, allowing a phone call to be made between the phone terminals 16a and 16b. For example, the phone network 11 is a public switched telephone network. In the present embodiment, a case where parties A and B have a phone call by respectively using the phone terminals 16a and 16b will be primarily described as an example.

The switchboard 7 controls phone calls taking place in the phone network 11 as well as sends information indicating the call status of each phone call to the data association system 1. For example, when a phone call between phone terminals is established, the switchboard 7 sends, to the data association system 1, call establishment information indicating that the phone call is established and the phone numbers of the phone terminals between which the phone call is established. Further, when the phone call is disconnected, the switchboard 7 sends, to the data association system 1, call disconnection information indicating that the phone call is disconnected. Furthermore, the switchboard 7 acquires call data exchanged between the phone terminals during the phone call, and hands the data to the data association system 1. It is to be noted that the switchboard 7 is an example communication control device and it functions as a phone call control server that controls phone calls taking place in the phone network 11.

Data communication terminals 15a and 15b are connected to the Internet 13. The data communication terminals 15a and 15b send and receive files and e-mails to/from the data association system 1 over the Internet 13. Although protocols such as HTTP, FTP and SIP are used in sending and receiving the files, there are no particular limitations to the protocols used in sending and receiving the files. On each of the data communication terminals 15a and 15b, a Web browser and an e-mail client software program are installed.

In the present embodiment, a case where the party A and the party B send and receive files and e-mails to/from the data association system 1 by respectively using the data communication terminals 15a and 15b will be described as an example.

The phone terminal 16a and the data communication terminal 15a do not have to be separate from each other like in the present embodiment, and a single terminal having the functions of the both terminals may be used. For example, by installing a software program that implements the function of an IP phone on each of the data communication terminals 15a and 15b, the call function and the function of sending and receiving files and e-mails may be implemented on a single terminal. Further, the number of the phone terminals and that of the data communication terminals are not limited to two as illustrated in FIG. 1.

The data association system 1 includes a communication monitoring unit 2, a sharing space generating unit 4, an association unit 5, a data communication unit 6 and a recording unit 9. For example, a call status table, a call data folder, a party table, a sharing space table and a sharing space folder are recorded in the recording unit 9.

As described above, the communication monitoring unit 2 receives the information indicating the call status of each phone call from the switchboard 7, and updates the call status table on the basis of the received information. For example, data indicating the call status of a phone call controlled by the switchboard 7 and data for specifying both parties of the phone call are recorded in the call status table phone call by phone call.

For example, when a phone call between the phone terminals 16a and 16b is initiated through the function of the switchboard 7, the communication monitoring unit 2 records, in the call status table, data indicating that the phone terminals 16a and 16b are having a phone call and data for identifying the parties using the both phone terminals 16a and 16b.

A call data acquiring unit 3 records voice data exchanged during a phone call controlled by the switchboard 7, and records the voice data as call data in the call data folder in the recording unit 9. In the call status table, information for associating the call data recorded in the call data folder with both parties of each call is recorded. Per phone call, the call data acquiring unit 3 may record the entire call data exchanged from the moment at which a phone call is established to the moment at which the phone call is disconnected or it may record only part of the entire call data. By narrowing down the range of the call data to be recorded per phone call to not the entire call data but to part of the call data, the size of the data to be recorded in the call data folder may be minimized. A method of narrowing down the range of the call data to be recorded per phone call will be described later.

Although the call data (voice data) is used as an example of communication data in the present embodiment, for example, video data, static image data or text data may be used as the communication data, in addition to the call data.

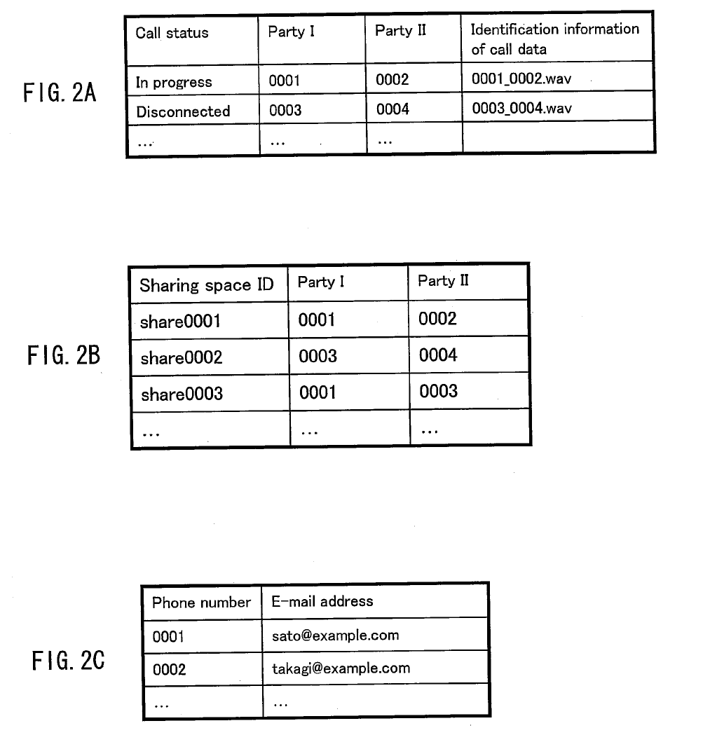

FIG. 2A is a diagram illustrating the call status table. In the call status table illustrated in FIG. 2A, the call status, the respective phone numbers of both parties I and II and information for identifying the corresponding call data are recorded phone call by phone call. Upon receipt of the call establishment information from the switchboard 7, the communication monitoring unit 2 generates an entry including the phone numbers of both parties of the phone call. In the entry “in progress” is recorded as the call status and information for identifying the call data that is recorded during the phone call and then recorded in the call data folder is recorded as identification information of the call data. Further, upon receipt of the call disconnect information from the switchboard 7, the communication monitoring unit 2 updates the entry of the phone call and changes the call status to “disconnected”. It is to be noted that in the example illustrated in FIG. 2A, the phone numbers of both parties of each phone call are used as information for specifying the both parties.

The sharing space generating unit 4 generates, in the file sharing space folder in the recording unit 9, a file sharing space to be shared by parties of each phone call indicated in the call status table. For example, the sharing space generating unit 4 generates, in the file sharing space folder, an individual folder corresponding to each phone call as the file sharing space. Here, the file sharing space is a logical memory area accessible to data communication terminals. In the present embodiment, a case where the file sharing space of each phone call is an individual folder that is further created in the file sharing space folder is described as an example. However, the form of the file sharing space is not limited to a folder, and a certain logical memory area such as a directory, a file itself or a Web page may be used as the file sharing space.

The sharing space generating unit 4 generates a sharing space ID for identifying the file sharing space generated for each phone call. The sharing space generating unit 4 records, in the sharing space table in the recording unit 9, the sharing space ID in a state where the ID is associated with information for specifying the parties that share the file sharing space indicated by the sharing space ID.

FIG. 2B is a diagram illustrating an example of the sharing space table. In the example illustrated in FIG. 2B, sharing space IDs and the respective phone numbers of both parties I and II that share each file sharing space indicated by each sharing space ID are recorded in the sharing space table.

The data communication unit 6 allows the data communication terminals 15a and 15b to upload files to and download files from the file sharing space. For example, the parties A and B may upload a file to the file sharing space by inputting, in the Web browser of the data communication terminals 15a and 15b, the URL for specifying the file sharing space to which the file is uploaded and information for specifying the file to be uploaded.

The sharing space generating unit 4 sends access information for accessing the file sharing space to the data communication terminals 15a and 15b of the both parties A and B so that they may access the generated file sharing space through the data communication terminals 15a and 15b. The sharing space generating unit 4 may send the URL for specifying the file sharing space as the access information, for example.

At that time, the sharing space generating unit 4 makes reference to the sharing space table as well as the party table previously recorded in the recording unit 9 so as to specify the data communication terminals 15a and 15b of the both parties A and B to which the access information is to be sent. In the party table, data for associating the parties specified in the call status table with the data communication terminals used by these parties is recorded. For example, in the party table, the phone numbers and the e-mail addresses or the user IDs of the parties are recorded in a state where they are associated with each other. Such data in the party table is recorded in advance by the parties by inputting the data through the data communication terminals 15a and 15b.

FIG. 2C is a diagram illustrating an example of the party table. In the party table illustrated in FIG. 2C, the phone numbers for specifying the parties and the e-mail addresses of the parties specified by the phone numbers are recorded in a state of being associated with each other.

For example, when the sharing space generating unit 4 generates a file sharing space whose sharing space ID is “Share0001”, it acquires the phone numbers “0001” and “0002” respectively belonging to the parties who may access the file sharing space having the sharing space ID=“Share0001”. The sharing space generating unit 4 may acquire, from the party table illustrated in FIG. 2C, the e-mail addresses “sato@example.com” and “takagi@example.com”, which respectively correspond to the acquired phone numbers, so that an e-mail containing the access information (the URL for specifying the file sharing space, for example) to the file sharing space may be sent to the data communication terminals of the both parties. As a result, the both parties may upload or download files to/from the file sharing space through their data communication terminals.

Upon receipt of a file uploaded to the file sharing space from the data communication terminal 15a and the URL for specifying the file sharing space, the data communication unit 6 records the received file in the file sharing space specified by the URL. Further, upon receipt of the URL for specifying the file sharing space and a request from the data communication terminal 15b to download the file, the data communication unit 6 sends the file to the communication terminal 15b from the file sharing space specified by the URL. Instead of the URL for specifying the file sharing space, the data communication unit 6 may receive authentication data for specifying a user, such as a user ID and a password, to specify a file sharing space accessible to the user.

When the data communication unit 6 records the file uploaded to the file sharing space, the association unit 5 specifies the call data to be associated with the recorded file and associates the specified call data with the file. The association unit 5 specifies the call data to be associated with the file by making reference to the sharing space table and the call status table. As a result, the association unit 5 may specify the call data of the phone call corresponding to the file sharing space to which the file is uploaded and whose call status is in progress as the call data to be associated with the file.

For example, the association unit 5 makes reference to the sharing space table to specify the parties that share the file sharing space to which the file is uploaded. Then, the association unit 5 makes reference to the call status table to specify the call data of the phone call between the specified parties.

The association unit 5 may associate the file and the call data with each other by compressing them into a single compression file and recording the compression file in the file sharing space. For example, the association unit 5 may associate the file and the call data with each other by recording them in a folder newly created in the file sharing space and compressing the folder to create a single compression file. Examples of compression formats include ZIP, LZH and the like. However, there are no particular limitations to the compression format in the present embodiment.

Here, a case where when the parties A and B are having a phone call respectively using the phone terminals 16a and 16b and the party A uploads a file to the file sharing space through the data communication terminal 15a will be described. In this case, the uploaded file is recorded in the file sharing space as a single compression file by being combined with the call data exchanged during the phone call between the parties A and B. Thereafter, the party B may download the compression file from the file sharing space through the data communication terminal 15b. For example, the party B expands the downloaded compression file on the data communication terminal 15b. Consequently, the party B may make reference to the file uploaded by the party A as well as the call data of the phone call between the parties A and B at the time when the file was uploaded.

It is to be noted that the association performed by the association unit 5 is not limited to the compression method as described above. For example, the association unit 5 may associate the file and the call data with each other by recording, in the recording unit 9, an association table (not shown) in which information indicating the recorded location of the file uploaded to the file sharing space and information indicating the recorded location of the corresponding call data are recorded in a state of being associated with each other. In this case, when downloading, to the data communication terminal 15b, the file uploaded to the file sharing space from the data communication unit 15a, the data communication unit 6 makes reference to the association table and allows the data communication terminal 15b to download the corresponding call data as well. As a result, when the party B downloads the file uploaded by the party A to the data communication terminal 15b, the call data at the time when the file was uploaded is also downloaded to the data communication terminal 15b.

Further, as other example of associating the file and the call data, the association unit 5 may write information for accessing the corresponding call data into the file uploaded to the file sharing space. In this case, each call data in the call data folder is recorded in a state of being accessible over the Internet 13 by designating the URL in the web browser of the data communication terminal 15a or 15b. The association unit 5 may associate the call data and the file with each other by writing the URL for accessing the call data in the call data folder into the file uploaded to the file sharing space. For example, when the party B downloads the file to the data communication terminal 15b from the file sharing space, the party B may access the call data associated with the file by designating the URL written in the file in the Web browser of the communication terminal 15b.

It is to be noted that instead of writing the URL for accessing the call data into the uploaded file, the association unit 5 may create a single compression file by combining the uploaded file and a text file containing the URL. Further, when the data communication unit 6 downloads the file in the file sharing space, it may also download a file in which the URL for accessing the call data associated with the file is described.

It is to be noted that the association performed by the association unit 5 is not limited to the above examples as long as the call data is in a state of being accessible to the parties A and B by accessing the file in the file sharing space.

The sharing space generating unit 4 may delete the file sharing space when the file uploaded thereto is downloaded. Further, the sharing space generating unit 4 may receive an explicit instruction from the party A or B to delete the file sharing space and delete the file sharing space on the basis of the instruction. Or, the sharing space generating unit 4 may delete the file sharing space after a lapse of certain time considered to be adequate for the party A or B to confirm the uploaded file. The timing at which the file sharing space is deleted may be set arbitrarily.

The above data association system 1 may be formed by a computer, such as a personal computer or a server. The functions of the communication monitoring unit 2, the call data acquiring unit 3, the shared space generating unit 4, the association unit 5 and the data communication unit 6 may be achieved by a CPU included in the computer executing specific programs. Further, the recording unit 9 is achieved by a recording medium included in the computer or a recording medium accessible to the computer. For example, the recording medium is a hard drive, a semiconductor memory, a flexible disk, a DVD, etc and there are no limitations to the type of recording medium.

The configuration of the data association system 1 is not limited to that illustrated in FIG. 1. For example, the data association system 1 does not have to be constructed on a single computer and the functions of the data association system 1 may be dispersed over a plurality of computers. Further, the recording unit 9 does not have to be formed by a single recording device and for example, a file sharing folder may be recorded in other recording device accessible to a computer constituting the data association system 1.

(Operation Example of the Data Association System 1)

[Example of File Sharing Space Generation and Deletion Processes]

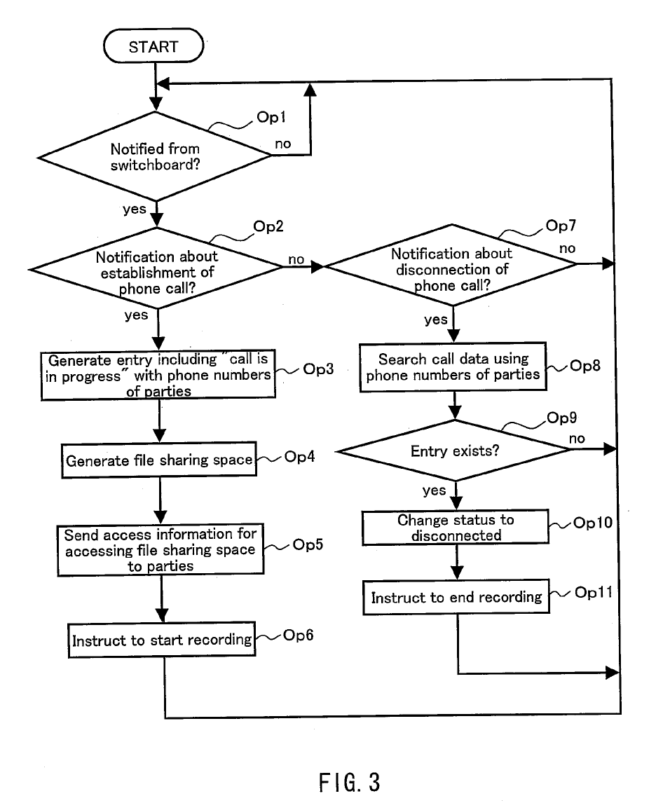

FIG. 3 is a flowchart illustrating an operation example of the communication monitoring unit 2 and the sharing space generating unit 4 in the present embodiment. In the example illustrated in FIG. 3, when the communication monitoring unit 2 detects a notification from the switchboard 7 (yes at Op1), it determines whether or not the notification is about the establishment of a phone call (Op2).

For example, when the notification is about the establishment of a phone call between the phone terminals 16a and 16b (yes at Op2), the communication monitoring unit 2 generates, in the call status table, an entry including the phone numbers of the both phone terminals 16a and 16b used in the established phone call and data indicating the call status “in progress” (Op3). For example, when the phone numbers of the phone terminals 16a and 16b are “0001” and “0002”, respectively, an entry including the phone numbers “0001” and “0002” and the call status “in progress” is generated as in the example of the call status table illustrated in FIG. 2A.

Next, the sharing space generating unit 4 generates, in the sharing space folder in the recording unit 9, a file sharing space to be shared by the both parties A and B of the established phone call (Op4). For example, the sharing space generating unit 4 generates, in the sharing space folder in the recording unit 9, an individual folder accessible to the parties A and B as the file sharing space. Furthermore, the sharing space generating unit 4 newly generates a sharing space ID for identifying the generated file sharing space. Then, the sharing space generating unit 4 generates an entry including the sharing space ID and the phone numbers of the both phone terminals 16a and 16b and adds the entry to the sharing space table.

For example, when the sharing space ID is “share001”, an entry including the phone numbers “0001” and “0002” and the sharing ID “share001” is added as illustrated in FIG. 2B. Consequently, data for associating the newly generated file sharing space and the parties A and B that share the file sharing space with each other is added to the sharing space table.

Next, the sharing space generating unit 4 sends access information for accessing the file sharing space to the parties A and B (Op5). For example, the sharing space generating unit 4 makes reference to the party table as illustrated in FIG. 2C and acquires the e-mail addresses “sato@example.com” and “takagi@example.com”, which respectively correspond to the phone numbers “0001” and “0002”.

The sharing space generating unit 4 sends an e-mail containing the information for accessing the file sharing space (e.g., the URL for specifying the file sharing space, etc.) to the acquired e-mail addresses as destinations. As a result, the e-mail containing the access information for accessing the file sharing space may be sent to the both parties A and B, for example. The parties A and B receive the e-mail using the data communication terminals 15a and 15b. Consequently, the both parties A and B may access the file sharing space from the data communication terminals 15a and 15b.

The communication monitoring unit 2 records voice data exchanged during the established phone call between the call terminals 16a and 16b, and gives an instruction to start a process of recording the voice data as the call data (Op6). The recording process will be described later in detail.

In contrast, when it is determined at Opt that the notification received from the switchboard 7 is not about the establishment of a phone call (no at Op2), the communication monitoring unit 2 determines whether or not the notification is about the disconnection of a phone call (Op7).

When the notification is about the disconnection of a phone call (yes at Op7), the communication monitoring unit 2 searches the call status table using the phone numbers of the both phone terminals used in the disconnected call (Op8). When it is found out that there is no entry in the call status table that includes the phone numbers of the both phone terminals used in the disconnected phone call as a result of the search (no at Op9), the communication monitoring unit 2 returns to the notification waiting state (Op1).

When it is found out that there is an entry in the call status table that includes the phone numbers of the both phone terminals used in the disconnected phone call as a result of the search (yes at Op9), the communication monitoring unit 2 updates the entry and changes the call status to “disconnected” (Op10).

Further, the communication monitoring unit 2 instructs the call data acquiring unit 3 to end the recording of the voice data of the disconnected phone call (Op11).

When a phone call is established through the processes in the flowchart illustrated in FIG. 3, a file sharing space is generated, and not only that the parties of the phone call become accessible to the file sharing space but also recording of the call data starts. Further, when the phone call is disconnected, the recording of the call data ends. It is to be noted that the processes illustrated in FIG. 3 is an example, and the operations of the communication monitoring unit 2 and the sharing space generating unit 4 are not limited to the above.

[Example of Recording Process]

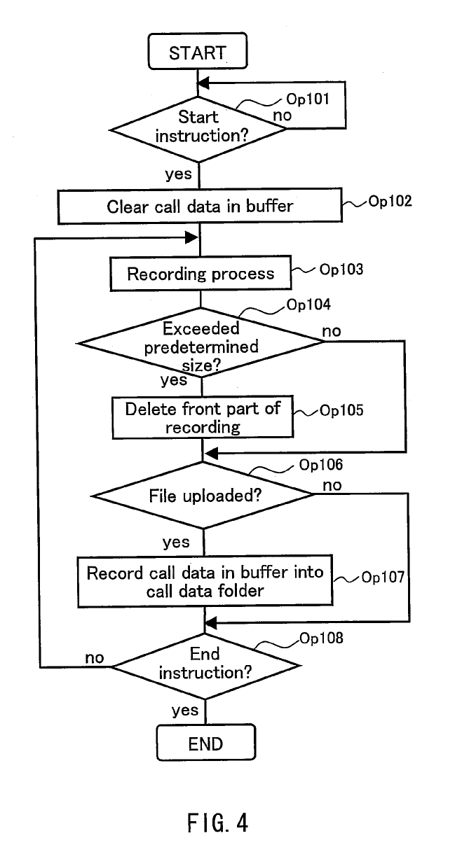

Next, an operation example of the call data acquiring unit 3 in the present embodiment will be described with reference to FIG. 4.

In the example illustrated in FIG. 4, when the call data acquiring unit 3 receives an instruction from the communication monitoring unit 2 to start recording call data (yes at Op101), it clears call data stored in the buffer (Op102) and starts the recording process (Op103). When the communication monitoring unit 2 gives the instruction to start the recording process, it notifies also the phone numbers of the both phone terminals 16a and 16b used in the phone call to be recorded. As a result, the call data acquiring unit 3 may specify the phone call from which the call data is to be acquired.

At Op103, the call data acquiring unit 3 acquires, from the switchboard 7, voice data exchanged between the phone terminals 16a and 16b in the phone call to be recorded, and records the voice data sequentially in the buffer as the call data.

When the size of the call data being recorded in the buffer exceeds a specific size (yes at Op104), the call data acquiring unit 3 deletes the front part of the call data by the exceeded amount (Op105). For example, the call data acquiring unit 3 may implement the processes at Op104 and Op105 by sequentially storing the call data in an FIFO (first in first out) cue buffer having the specific size.

As a result, the amount of the call data equivalent to the specific size is always recorded in the buffer. Further, voice data of the phone call from the latest point in time to certain time prior to the latest point in time is recorded. In other words, the latest call data is always recorded in the buffer in amount equivalent to the certain time.

When a file is uploaded to the file sharing space corresponding to the phone call to be recorded (yes at Op106), the call data acquiring unit 3 records, in the call data folder, the call data stored in the buffer at that point in time (Op107). Consequently, the voice data of the phone call from the point in time at which the file was uploaded to certain time prior to the file uploading is recorded in the call data folder as the call data.

When the call data acquiring unit 3 records the call data into the call data folder, it records, in the call status table, information for identifying the call data in a state where the call data is associated with data for specifying the parties of the corresponding phone call. For example, when the phone call to be recorded is a phone call between the phone terminal 16a whose phone number is “0001” and the phone terminal 16b whose phone number is “0002” and the identification information of the call data of the phone call recorded in the call data folder is “0001_{—}0002.wav”, the call data acquiring unit 3 records “0001_{—}0002.wav” as the call data identification data in the entry including the phone numbers “0001” and “0002” as illustrated in FIG. 2A.

The call data acquiring unit 3 may detect the occurrence of file uploading by receiving a notification about the occurrence of file uploading from the data communication unit 6.

In a case where a plurality of times of file uploading take place during one phone call, call data at the time of each uploading may be recorded in the call data folder or the call data in the call data folder may be overwritten every time uploading takes place.

Through the processes illustrated in FIG. 4, the call data whose range is narrowed down relative to the point at which the file is uploaded is recorded. It is to be noted that the timing at which the call data is recorded into the call data folder is not limited to the point at which a file is uploaded. For example, the timing at which the call data is recorded into the call data folder may be a point in time after certain time from the point in time at which a file is uploaded or a point in time at which the file is downloaded. Or, when the association unit 5 associates the call data and the file with each other, an instruction may be given to the call data acquiring unit 3 to record the call data.

It is to be noted that the processes illustrated in FIG. 4 are an example, and the recording of a phone call performed by the call data acquiring unit 3 is not limited to this example. For example, the process of limiting the range of the call data to be recorded in the call data folder is not limited to deleting the front part of the call data when the size of the call data in the buffer exceeds a specific size as performed at Op104 and Op105.

Upon receipt of a recording start instruction signal from the communication terminal 16a or 16b, the communication monitoring unit 2 may delete call data recorded prior to the receipt of the signal from the buffer, instead of performing the processes at Op104 and Op105. As a result, a user may instruct to start recording through the communication terminal 16a or 16b. Further, upon receipt of a recording end instruction signal, the communication monitoring unit 22 may record the call data in the buffer into the call data folder, instead of performing the processes at Op106 and Op107. As a result, a user may instruct to end recording through the communication terminal 16a or 16b.

Examples of the recording start instruction signal include PB (Push Button) sound sent from a phone terminal. The PB sound is a type of signal that is sent by a caller by operating a phone terminal during a phone call. For example, the signal is sent by the caller by pressing a button of the phone during a phone call. The PB sound is also referred to as a PB signal or a tone signal.

Further, as another example, instead of performing the processes at Op104 and Op105, upon detection of a silent pause in the call data, the communication monitoring unit 22 may delete the part of the call data prior to the silent pause from the buffer. Consequently, the phone conversation after the silent pause may be recorded in the call data folder. Generally, it is highly likely that a topic will be changed after the silent pause. Thus, by recording only the phone conversion after the silent pause, conversations on unnecessary topics are omitted, and thereby the size of the call data may be reduced. For example, as a way to detect silent pauses, the silent pauses are detected by setting a pause with the voice level smaller than a specific level as a silent pause or other well-known voice recognition techniques may be used.

Further, instead of performing the processes at Op106 and Op107, upon detection of a silent pause in the call data, the communication monitoring unit 22 may record the call data in the buffer into the call data folder. Consequently, the call data prior to the silent pause is recorded in the call data folder.

[Example of Process of Associating File with Call Data]

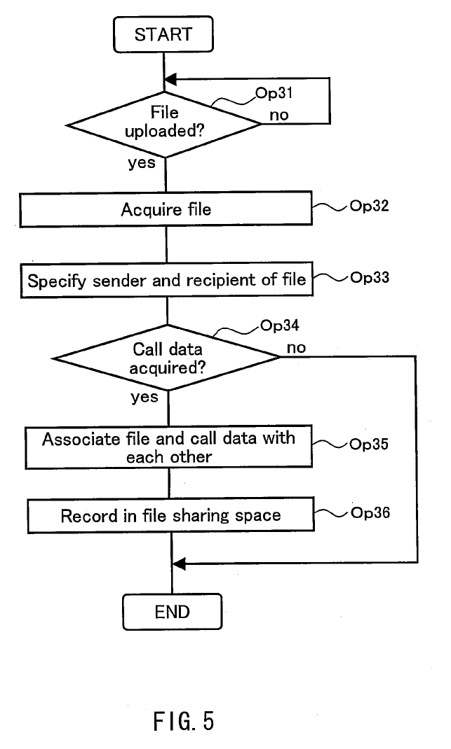

FIG. 5 is a flowchart illustrating a series of processes in which the association unit 5 associates a file uploaded to a file sharing space and the corresponding call data in the call data folder with each other. As an example, a case where a file is uploaded to the file sharing space generated by the process at Op4 illustrated in FIG. 3 will be described. In other words, in a case where a phone call between the phone terminals 16a and 16b of the parties A and B is established and a file sharing space corresponding to this phone call is generated, the processes to be performed by the association unit 5 and the data communication unit 6 when the party A uploads a file from the data communication terminal 15a during the phone call will be described.

The data communication unit 6 accepts uploading of the file to the file sharing space generated at Op3 in FIG. 3 (Op31). For example, the party A sends the file by designating in the Web browser of the data communication terminal 15a the URL (the URL for specifying the file sharing space of the parties A and B) notified from the sharing space generating unit 4 at Op5 in FIG. 3. Consequently, the party A may upload the file to the file sharing space. The URL includes, for example, a sharing space ID for specifying the file sharing space.

When the data communication unit 6 accepts the file uploading to such a file sharing space, the association unit 5 acquires the uploaded file and the designated URL from the data communication unit 6 (Op32). Further, the data communication unit 6 notifies the communication data acquiring unit 3 that the file is uploaded. Consequently, the file uploading is detected at Op106 in FIG. 4.

The association unit 5 extracts the sharing space ID of the file sharing space from the URL acquired from the data communication unit 6, and makes reference to the sharing space table to specify the both parties corresponding to the sharing space ID. As a result, the association unit 5 specifies the parties A and B as the sender and the recipient of the uploaded file (Op33).

Then, the association unit 5 specifies the current phone call between the specified parties A and B from the call status table and further acquires the call data of the phone call from the call data folder in the recording unit 9 (Op34).

For example, when the sharing space ID is “share0001”, the association unit 5 makes reference to the sharing space table illustrated in FIG. 2B, and acquires the phone numbers “0001” and “0002” of the both parties A and B. The association unit 5 makes reference to the call status table illustrated in FIG. 2A, and acquires the call data identification information “0001_{—}0002.wav” of the phone call (call status=“in progress”) between the parties with the phone numbers “0001” and “0002”. The association unit 5 acquires the call data specified by “0001_{—}0002.wav” from the call data folder (yes at Op34). When there is no entry including “0001” and “0002” in the call status table (no at Op34), the association unit 5 does not acquire call data.

Then, the association unit 5 associates the uploaded file acquired at Op32 and the call data acquired at Op34 with each other (Op35). For example, the association unit 5 records the call data and the file in a single file and compresses the file to create a single compression file.

The association unit 5 records the compression file in the file sharing space (Op36). Consequently, the uploaded file is recorded in the file sharing space in a state of being associated with the call data. As a result, the parties A and B may access the compression file recorded in the file sharing space by using the data communication terminals 15a and 15b.

Instead of associating the call data with the file using a compression file, the association unit 5 may perform the other association processes described above.

Further, in addition to recording the compression file in the file sharing space, the association unit 5 may instruct the data communication unit 6 to send the compression file to the communication terminal 15b of the party B. As a result, the file sent from the data communication terminal 15a of the party A to the data association system 1 is sent to the data communication terminal 15b of the party B in a state of being associated with the call data.

In this way, through the processes illustrated in FIG. 5, when the file is uploaded to the file sharing space, the file is recorded in the file sharing space in a state of being associated with the call data of the phone call at the time when the file was uploaded. As a result, without requiring the both parties A and B to put extra time and effort, data indicating the circumstances (contexts) under which the file was uploaded is automatically recorded as call data in a state of being associated with the file.

(Example of Screen Display)

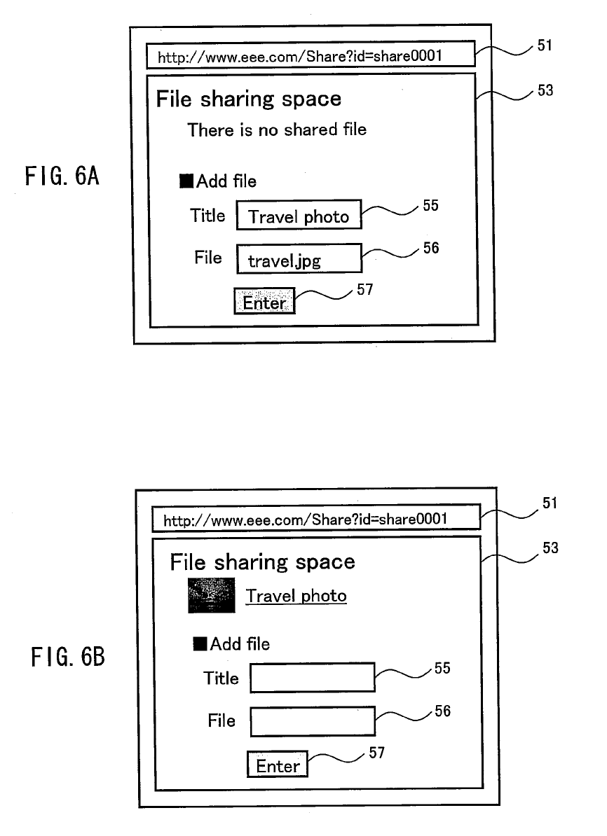

Here, an example of a screen displayed on the data communication terminal 15a when the party A uploads the file to the file sharing space will be described. FIG. 6A is a diagram illustrating an example of a displayed screen when the party A accesses the file sharing space by designating the URL sent with an e-mail in the Web browser of the data communication terminal 15a.

In the screen illustrated in FIG. 6A, a URL input area 51, a content display area 53, a title input area 55, a file name input area 56 and an enter button 57 are displayed. For example, the party A may access the file sharing space for the parties A and B by inputting the URL sent thereto with an e-mail in the URL input area 51. A file already uploaded to the file sharing space is displayed in the content display area 53. Since no file exists in the file sharing space in the example illustrated in FIG. 6A, the text “there is no shared file” is displayed.

Further, when the party A wants to upload a file to the file sharing space, he/she inputs the title of the file in the title input area 55 as well as the name of the file that he/she wants to upload in the file name input area 56, and clicks the enter button 57.

When the enter button 57 is clicked, the Web browser sends, by using the POST method of the HTTP protocol, the title “travel photo” inputted in the title input area 55 and the file with the file name “travel.jpg” inputted in the file name input area 56 to the specific URL indicting the file sharing space.

In this example, the file, the title and the URL are sent to the data association system 1. In the data association system 1, the data communication unit 6 receives the file, the title and the URL and the processes illustrated in FIG. 5 are performed. Then, the file uploaded by the party A is recorded in the file sharing space by the association unit 5 in a state of being associated with the call data, as described above.

FIG. 6B is a diagram illustrating an example of a screen of the Web browser when the display of the content display area 55 is updated after the enter button in the screen illustrated in FIG. 6A is clicked and the file is uploaded. In the example illustrated in FIG. 6B, the title “travel photo” and a thumbnail of the uploaded file are displayed.

A link may be set to the title “travel photo”. For example, the link may be set such that when the title “travel photo” is clicked, the file “travel.jpg” uploaded to the sharing space and the call data associated with the file are downloaded. Further, a link to the call data associated with the file may be provided next to the link to such a file, for example.

As described above, the party A may access the file sharing space by using the data communication terminal 15a. On the other hand, the party B may also access the file sharing space by using the data communication terminal 15b. And, the association unit 5 associates a file uploaded to the file sharing space by the party A or B and the call data of the phone call between the parties A and B with each other. Then, the parties A and B may access the file uploaded to the file sharing space as well as the call data associated with the file by using the data communication terminals 15a and 15b. It is to be noted that each of the screens illustrated in FIGS. 6A and 6B is an example, and the display form of the screen is not limited to this example.

### Embodiment 2

### System Configuration

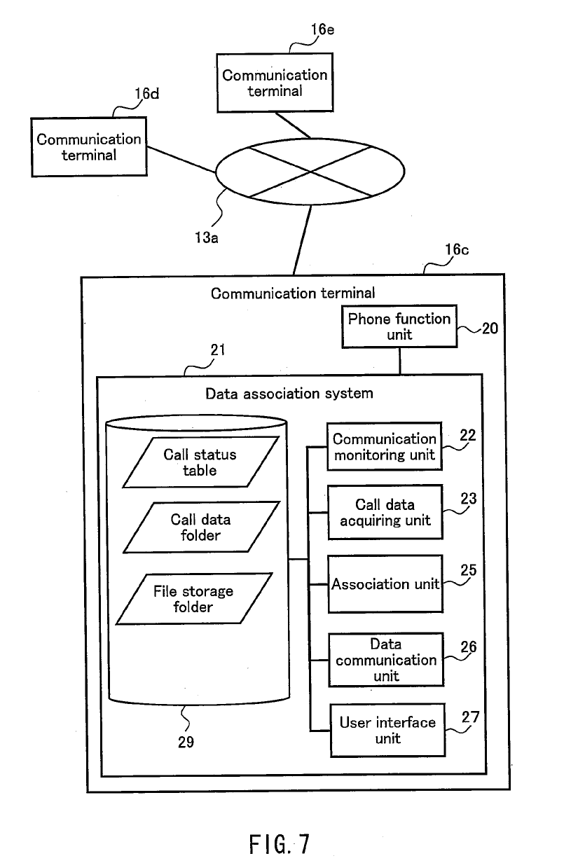

FIG. 7 is a functional block diagram illustrating the configuration of an entire system including a data association system according to the present embodiment. A data association system 21 illustrated in FIG. 7 is a system incorporated in a communication terminal 16c connected to a network 13a. The communication terminal 16c may be a general purpose computer such as a personal computer on which a software program for implementing the telephone function such as a softphone is installed or may be a telephone including a computer.

The communication terminal 16c includes a phone function unit 20 and the data association system 21. For example, the phone function unit 20 is a function that allows a phone call to be made to a communication terminal 16e or 16b over the network 13a, and it is implemented by a well-known telephone technique.

The data association system 21 includes a communication monitoring unit 22, a call data acquiring unit 23, an association unit 25, a data communication unit 26, a user interface unit 27 and a recording unit 29. The respective functions of the communication monitoring unit 22, the call data acquiring unit 23, the association unit 25, the data communication unit 26 and the user interface unit 27 may be implemented by a CPU included in the computer of the communication terminal 16c executing specific programs. Further, the recording unit 29 may be achieved by a recording medium included in the computer or a recording medium accessible to the computer.

The communication monitoring unit 22 monitors the status of a phone call that is made through the phone function unit 20. For example, the communication monitoring unit 22 detects the beginning and the end of a phone call between the phone function unit 20 and other communication terminal 16d or 16e, and updates a call status table on the basis of the detection result. For example, in the call status table, data indicating the status of a phone call that is made through the phone function unit 20 and data for specifying the party on the other end (hereinafter referred to as other party) of the phone call that is made through the phone function unit 20 are recorded.

Further, upon detection of the beginning of a phone call between the phone function unit 20 and other communication terminal 16d or 16e, the communication monitoring unit 22 instructs the call data acquiring unit 23 to start recording the call data, and upon detection of the end of the phone call, the communication monitoring unit 22 instructs the call data acquiring unit 23 to end the recording.

The call data acquiring unit 23 records voice data exchanged during a phone call between the phone function unit 20 and other communication terminal and records the voice data into a call data folder in the recording unit 29 as the call data.

In the call status table, data for associating the call data recorded in the call data folder with the data for specifying the other party is recorded.

The call data acquiring unit 23 may perform the recording process similarly to the call data acquiring unit 3 in Embodiment 1. For example, upon receipt of an instruction from the communication monitoring unit 22 to start the recording, the call data acquiring unit 23 starts recording the call data into the buffer. As will be described later, the call data in the buffer may be recorded into the call data folder at the point in time at which the data communication unit 26 receives a file from the other party of the phone call relating to the call data.

The communication monitoring unit 22 records, in the call status table, the phone number of the other party of the phone call that is made through the phone function unit 20 and the identification information of the call data of the phone call in a state where they are associated with each other. The data for specifying the other party recorded in the call status table may be data for identifying the communication terminal of the other party such as the phone number of the other party.

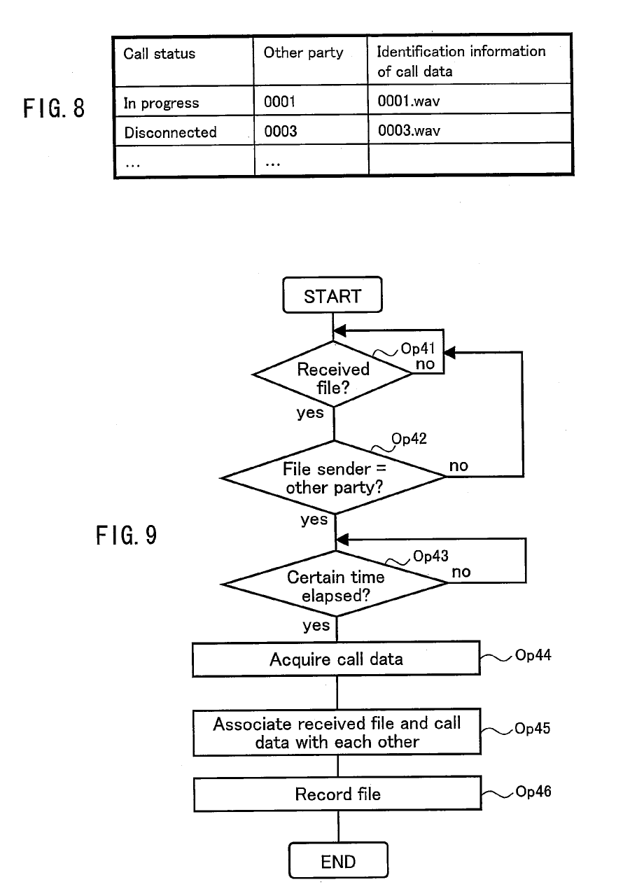

FIG. 8 is a diagram illustrating an example of data recorded in the call status table in the present embodiment. In the example illustrated in FIG. 8, the call status, the phone number of the other party, and the information for identifying the call data are recorded in the call status table phone call by phone call. When the phone function unit 20 initiates a phone call with other communication terminal (e.g., the communication terminal 16d), the communication monitoring unit 22 generates, in the call status table, an entry including the phone number of the communication terminal 16d used by the other party of the phone call. In the entry, the call status “in progress” is recorded as identification information of the call data. Further, information for identifying the call data that is recorded during the phone call and then recorded into the call data folder is also recorded in the entry. When the phone function unit 20 ends the phone call, the communication monitoring unit 22 updates the entry of the phone call and changes the call status to “disconnected”.

In the example illustrated in FIG. 8, the phone number of the communication terminal of the other user is used as the data for specifying the other party. However, the data for specifying the other party is not limited to a phone number and the e-mail address, etc. of the other party may be used.

The data communication unit 26 receives a file sent to the communication terminal 16c from other communication terminal (e.g., the communication terminal 16d or 16e). The data communication unit 26 communicates the file with other communication terminal 16d or 16e by using a protocol such as SIP, HTTP or FTP over the network 13a, for example. The protocol used by the data communication unit 26 does not have to be a different protocol from that used by the phone function unit 20 in making a phone call. Further, when the phone function unit 20 is implemented by a softphone, for example, the data communication unit 26 may be included in the phone function unit 20 as one of its functions.

For example, the data communication unit 26 may exchange files with the communication terminal of the other party by acquiring the information for specifying the other party of the phone call from the call status table.

For example, when the phone function unit 20 initiates a call session using SIP, the data communication unit 26 may generate a session for exchanging files with the other party of the phone call by similarly using SIP. Further, when the other party is specified by an IP address in the call status table, the data communication unit 26 may acquire the IP address of the other party of the phone call from the call status table to exchange files with the communication terminal having the IP address by using FTP.

Further, the data communication unit 26 may upload a file to a specific server using HTTP or the like and send the URL for accessing the uploaded file to the communication terminal of the other party. Furthermore, when the e-mail address of the other party is known, the data communication unit 26 may exchange files using e-mails.

When a phone call is made through the phone function unit 20 to other communication terminal and the data communication unit 26 receives a file sent from the other party of the phone call, the association unit 25 records the file in the recording unit 29 in a state where the file is associated with the call data recorded during the phone call.

At this time, the association unit 25 needs to determine whether or not the file received by the data communication unit 26 is sent from the communication terminal of the other party. The association unit 25 makes reference to the call status table to acquire information on the other party and may make the determination on the basis of this information. For example, the association unit 25 may acquire the phone number of the other party of the phone call from the call status table to determine whether or not the phone number is the same as that of the sender of the file that the data communication unit 26 received.

It is to be noted that the information for specifying the sender of the file is not limited to a phone number. For example, an e-mail address, etc. may be used. In this case, the association unit 25 makes reference to the party table in Embodiment 1 which is illustrated in FIG. 2C to acquire the phone number corresponding to the e-mail address of the sender and compare this phone number with that of the other party of the phone call.

Examples of associating a file and call data with each other performed by the association unit 25 include, similarly to Embodiment 1, recording the file and the call data by compressing them as a single file, recording pieces of the information respectively indicating the recorded locations of the file and the call data in a state where they are associated with each other, and including into or adding to the file information for accessing the file.

The user interface unit 27 has functions of receiving an input inputted by the user through an input device (e.g., a keyboard, a pointing device, buttons, etc.) included in the communication terminal 16c and presenting information to the user through an output unit (a display, a speaker, etc.) included in the communication terminal 16c. The user of the communication terminal 16c may make reference to a file recorded in the recording unit as well as the call data associated with the file through the user interface unit 27.

(Operation Example of Data Association System 21)

Next, an operation example of the data association system 21 will be described. FIG. 9 is a flowchart illustrating an example of a series of processes in which the data association system 21 receives a file and records the file in a state where the file is associated with call data.

In the processes illustrated in FIG. 9, when the data communication unit 26 receives a file from outside the communication terminal 16c (yes at Op41), the association unit 25 determines whether or not the sender of the file is the communication terminal of the other party of the phone call that is currently made through the phone function unit 20 (Op42).

For example, when the sender of the file that is received by the data communication unit 26 is specified by the phone number “0001”, the association unit 25 makes reference to the call status table illustrated in FIG. 8 and makes reference to the other party in each entry with the call status “in progress”. In this case, since the phone number of the other party is “0001” and he/she matches with the sender of the file, it is determined that the sender of the file is the communication terminal of the other party of the phone call that is currently made through the phone function 20 (yes at Op42).

It is to be noted that when an entry with the call status “in progress” is not recorded in the call status table at the time of file reception or the phone number of the other party recorded in the call status table does not match with that of the sender of the file, it is determined that the sender of the file is not the communication terminal of the other party of the phone call that is currently made through the phone function 20 (no at Op42).

When it is determined as yes at Op42, the association unit 25 instructs the call data acquiring unit 23 to record the call data of the phone call that is made through the phone function unit 20 into the call data folder after a lapse of certain time (yes at Op43).

Upon receipt of the instruction, the call data acquiring unit 23 moves the call data of the phone call that is currently made through the phone function unit 20 from the buffer and records the call data in the call data folder. Further, the call data acquiring unit 23 records the identification information of the call data recorded in the call data folder (e.g., “0001.wav”) in the call status table as identification information of the call data of the entry with the call status “in progress” in the call status table illustrated in FIG. 8.

Then, the association unit 25 acquires the call data recorded in the call data folder (Op44). The association unit 25 makes reference to the call status table illustrated in FIG. 8 and acquires the identification information “0001.wav” of the call data of the entry with the call status “in progress”. Thereafter, the association unit 25 acquires, among pieces of the call data recorded in the call data folder, the call data whose identification information is “0001.wav”.

In this way, the association unit 25 instructs the call data acquiring unit 23 to record call data into the call data folder after a lapse of certain time and acquires the recorded call data. Thus, it is possible to acquire call data after sufficient amount of call data has been stored.

The recording of the call data file by the call data acquiring unit 23 is not limited to the above example. Similarly to the recording process performed by the communication monitoring unit 2 described in Embodiment 1, a phone call may be recorded on the basis of an instruction from a user to start or end the recording or a silent pause may be detected and set the silent pause as a recording start or end position.

The association unit 25 associates the file received at Op41 and the call data acquired at Op44 with each other (Op45). This association process may be performed in the same manner as that performed by the association unit 5 in Embodiment 1.

The association unit 25 records the file associated with the call data into a file storage folder in the recording unit 29 (Op46). The file storage folder is a folder accessible to the user of the communication terminal 16c through the user interface unit 27.

As described above, through the processes illustrated in FIG. 9, in the communication terminal 16c, when receiving a file from other communication terminal when having a phone call with the communication terminal, call data exchanged during the phone call is recorded in a state of being associated with the file. As a result, the user of the communication terminal 16c may also make reference to the call data associated with the file when making reference to the received file. In this way, by making reference to the call data, the user may easily confirm the circumstances under which the phone call took place at the time he/she received the file. Thus, the user may confirm the business of the party with whom he/she had a phone call at the time of file reception or may determine whether or not he/she needs the file.

In the present embodiment, the phone function unit 20 and the data communication unit 26 of the communication terminal 16c communicate with other communication terminal 16d or 16e over the same network 13a. However, the phone function unit 20 and the data communication unit 26 may communicate with other communication terminal 16d or 16e over different networks (e.g., a phone network and a packet communication network).

### Embodiment 3

### System Configuration

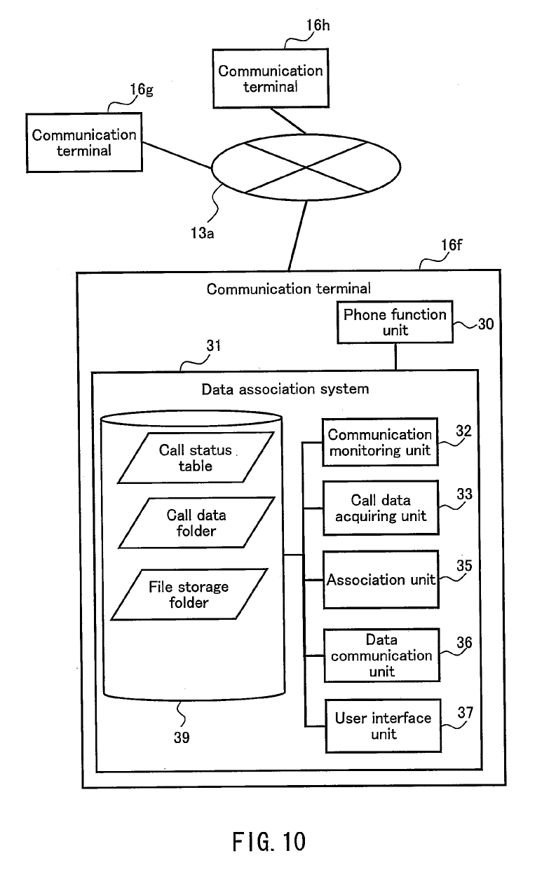

FIG. 10 is a functional block diagram illustrating the configuration of an entire system including a data association system according to the present embodiment. A data association system 31 illustrated in FIG. 10 is a system incorporated in a communication terminal 16f connected to a network 13a. For example, the communication terminal 16f may be a general purpose computer such as a personal computer on which a software program for implementing the telephone function such as a softphone is installed or may be a telephone including a computer.

The communication terminal 16f includes a phone function unit 30 and the data association system 31. Similarly to the phone function unit 20 in Embodiment 2, the phone function unit 30 is a function that allows a phone call to be made to a communication terminal 16g or 16h over the network 13a.

The data association system 31 includes a communication monitoring unit 32, a call data acquiring unit 33, an association unit 35, a data communication unit 36, a user interface unit 37 and a recording unit 39. The functions of the communication monitoring unit 32 are similar to those of the communication monitoring unit 22 in Embodiment 2 and the call data acquiring unit 33 is similar to the call data acquiring unit 23. Data to be recorded in the call status table is also similar to that in Embodiment 2.

The user interface unit 37 receives an instruction from a user to send a file to other communication terminal (e.g., the communication terminal 16g or 16h). Consequently, when having a phone call with other communication terminal through the phone function unit 30, the user may input an instruction signal for sending a file to the communication terminal of the other party. The instruction signal includes information for specifying the file to be sent and information for specifying the recipient. It is to be noted that the file to be sent which is specified by the instruction signal may be a file previously recorded in the recording unit 39 or a file inputted through the user interface unit 37.

Upon receipt of the instruction from the user to send the file to the communication terminal (e.g., the communication terminal 16g) of the other party, the user interface unit 37 notifies the association unit 35 the information for specifying the file to be sent and the information for specifying the recipient. The information for specifying the recipient includes the phone number, the e-mail address or the like of the communication terminal of the recipient. Hereinafter, a case where the information for specifying the recipient includes the phone number will be described.

The association unit 35 determines whether or not the file recipient is the other party of the phone call that is made through the phone function 30 by making reference to the call status table. For example, the association unit 35 may make the determination by acquiring, from the call status table, the phone number of the other party of the phone call that is made through the phone function unit 30, and checking whether or not the phone number is the same as that of the communication terminal of the file recipient. When the file recipient is the other party of the phone call, the association unit 35 temporarily records the file in a file storage folder in the recording unit 39 in a state where the file is associated with the call data recorded during the phone call.

The data communication unit 36 sends, to the file recipient, the file recorded in the recording unit 39 in a state where the file is associated with the call data.

Examples of associating a file and call data with each other performed by the association unit 35 include, similarly to Embodiment 1, recording the file and the call data by compressing them as a single file, recording pieces of the information respectively indicating the recorded locations of the file and the call data in a state where they are associated with each other, and including into or adding to the file information for accessing the file.

(Operation Example of Data Association System 31)

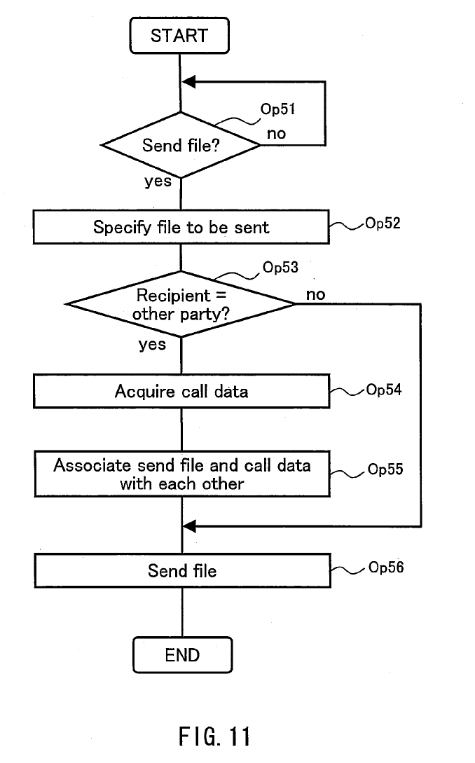

Next, an operation example of the data association system 31 will be described. FIG. 11 is a flowchart illustrating an example of a series of processes in which the data association system 31 receives an instruction from a user to send a file in a state where the file is associated with call data.

In the processes illustrated in FIG. 11, upon receipt of an instruction to send a file (yes at Op51), the user interface unit 37 acquires the file to be sent (Op52).

The instruction from the user to send the file includes information for specifying the file and information for specifying the file recipient. As an example, a file previously recorded in the file storage folder in the recording unit 39 is designated as the file to be sent and the phone number “0001” of the communication terminal 16g is designated as the recipient.

For example, the association unit 35 specifies the file designated by a file sending instruction signal from the user among files recorded in the file storage folder in the recording unit 39 (Op52).

The association unit 35 determines whether or not the other party of the phone call that is currently made through the phone function unit 30 is the file recipient (Op53). The association unit 35 may make the determination, for example, by making reference to the call status table illustrated in FIG. 8 to check whether or not the phone number of the other party in an entry with the call status “in progress” is the same as the phone number designated as the file recipient. In the example illustrated in FIG. 8, the phone number of the other party in such an entry with the call status “in progress” is “0001” and is the same as the phone number “0001” designated as the file recipient. In this case, it is determined that the other party of the phone call that is currently made through the phone function unit 30 is the file recipient.

It is to be noted that the file recipient does not have to be designated by a phone number. The file recipient may be designated by an e-mail address. In this case, the association unit 35 may make the determination at Op53 by making reference to the party table previously recorded in the recording unit 39 in Embodiment 1 illustrated in FIG. 2C.

When the other party of the phone call is the file recipient (yes at Op53), the association unit 35 instructs the call data acquiring unit 33 to record call data of the phone call that is made through the phone function unit 30 into the call data folder.

Upon receipt of the instruction, the call data acquiring unit 33 moves the call data of the phone call that is currently made through the phone function unit 30 from the buffer and records the call data in the call data folder. Further, the call data acquiring unit 33 recodes, in the call status table, the identification information (e.g., “0001.wav”) of the call data recorded in the call data folder as the identification information of the call data related to the entry with the call status “in progress” in the call status table illustrated in FIG. 8.

Then, the association unit 35 acquires the call data recorded in the call data folder (Op54). The association unit 35 acquires the identification data “0001.wav” of the call data related to the entry with the call status “in progress” by making reference to the call status table illustrated in FIG. 8. Then, the association unit 35 acquires call data whose identification information is “0001.wav” among pieces of call data recorded in the call data folder.

The association unit 35 associates the file specified at Op52 with the call data acquired at Op54 (Op55). The process at Op55 is similar to that at Op45 in FIG. 9. The data communication unit 36 sends the file being associated with the call data to the designated recipient (Op56).

As described above, in a case where the user inputs the file sending instruction signal when having a phone call with other communication terminal, through the series of processes illustrated in FIG. 11, the communication terminal 16f sends a file to the other party in a state where the file associated with the call data exchanged during the phone call. Thus, the user of other communication terminal to which the communication terminal 16f communicates may make reference to the call data associated with the file when making reference to the file sent from the communication terminal 16f. In other words, without putting time and effort into, for example, taking notes about the file, the user who received the file may confirm the circumstances under which the phone call took place at the time of receiving the file when making reference to the file. Further, without putting time and effort into, for example, attaching information such as the business and comments to the file, the user who sends the file may send, to the other user, the file together with the call data indicating the circumstances under which the file is sent.

In the present embodiment, the phone function unit 30 and the data communication unit 36 of the communication terminal 16f communicate with other communication terminal 16g or 16h over the same network 13a. However, the phone function unit 30 and the data communication unit 36 may communicate with other communication terminal 16g or 16h over different networks.

In Embodiments 2 and 3, each of the data association systems is incorporated in a communication terminal as an example. However, each of the data association systems may be included in a computer connected to a communication terminal, for example.

A system including the both functions of the data association system 21 described in Embodiment 2 and the data association system 31 described in Embodiment 3 may be included in a single communication terminal.

Although Embodiments 1 to 3 have been described above, the present invention is not limited thereto. For example, in the above embodiments, call data, which is voice intercommunicated during a phone call between a plurality of terminals and being recorded, is associated with a file as an example. However, communication data to be associated with a file is not limited to the call data. For example, a chat log which indicates the details of conversations exchanged during a chat may be associated with a file or the text of an e-mail may be associated with a file. Further, data with which the communication data is associated is not limited to a file.

The phone network in the above embodiments is a communication network that allows a phone call to be made between phones connected to the network. Examples of the phone network may include phone networks for connecting general phones including a public switched telephone network, and a phone network for connecting phones in the premises of schools or companies. Further, an IP network for connecting IP phones is also included in the phone network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A data association system comprising:
a communication monitoring unit that records, in a recording unit, communication status data containing data indicating a communication status of communication performed by a communication terminal and data for specifying at least one of both users in the communication;
a communication data acquiring unit that acquires first communication data that the communication terminal exchanges during the communication indicated by the communication status data and records the first communication data in the recording unit in a state where the first communication data is associated with the communication status data of the communication;
a data communication unit that makes second communication data accessible to the both users through communication different from the communication of the first communication data; and
an association unit that specifies, among in-progress communications indicated by the communication status data, communication held by the same users as the both users in the communication of the second communication data and makes the first communication data recorded in a state of being associated with the specified communication data accessible to the both users by associating the first communication data with the second communication data.

2. The data association system according to claim 1, wherein
the communication terminal includes at least the communication monitoring unit, the communication data acquiring unit, the data communication unit and the association unit,
the communication monitoring unit records, in the recording unit, communication status data containing data indicating a communication status of communication performed by the communication terminal and data for specifying other user in the communication performed by the communication terminal,
the communication terminal further includes a user interface unit that receives an input of an instruction from the user of the communication terminal to send the second communication data, and
the association unit specifies a recipient of the second communication data indicated by the send instruction received by the user interface unit, and when the recipient is the other user in the communication that is performed by the communication terminal and indicated by the communication status data recorded in the recording unit, the association unit causes the data communication unit to send the second communication data in a state where the second communication data is associated with the first communication data of the communication performed by the communication terminal.

3. The data association system according to claim 1, wherein
the communication terminal includes at least the communication monitoring unit, the communication data acquiring unit, the data communication unit and the association unit,
the communication monitoring unit records, in the recording unit, communication status data containing data indicating a communication status of communication performed by the communication terminal and data for specifying other user in the communication performed by the communication terminal,
the communication terminal further includes a user interface unit for allowing the user of the communication terminal to access data recorded in the recording unit, and
the data association unit specifies a sender of second communication data received by the data communication unit, and when the sender is the other user in the communication that is performed by the communication terminal and indicated by the communication status data recorded in the recording unit, the association unit records the second communication data in the recording unit in a state where the second communication data is associated with the first communication data of the communication performed by the communication terminal and being accessible to the user of the communication terminal through the user interface unit.

4. The data association system according to claim 1 further comprising a server connected to a communication control device that controls communication among a plurality of communication terminals, the server including at least the communication monitoring unit, the communication data acquiring unit, the data communication unit and the association unit,
wherein the communication monitoring unit detects, through the communication control device, communication between at least two users among users of the plurality of communication terminals and records, in the recording unit, data indicating a communication status of the detected communication and data for specifying the both users in the communication as communication status data, and
when the both users of the second communication data being made accessible by the data communication unit are the both users in the communication indicated by the communication status data recorded in the recording unit, the association unit records the second communication data in the recording unit in a state where the second communication data is associated with the first communication data of the communication and the second communication data and the first communication data are accessible to the both users.

5. The data association system according to claim 1, wherein
the data association unit associates the first communication data and the second communication data with each other by compressing the first communication data together with the second communication data to generate a single file.

6. The data association system according to claim 1, wherein
the association unit associates the first communication data and the second communication data with each other by writing in or adding to the second communication data information for accessing the first communication data.

7. The data association system according to claim 1, wherein
the association unit associates the first communication data and the second communication data with each other by generating association data in which data indicating a recoded location of the first communication data and data indicating a recorded location of the second communication data are recorded in a state of being associated with each other.

8. The data association system according to claim 1, wherein
the association unit determines a range of the first communication data to be associated with the second communication data relative to a point in time at which the data communication unit sends the second communication data or the data communication unit receives the second communication data.

9. The data association system according to claim 1, wherein
the association unit detects an instruction signal inputted by the user of the communication terminal or the other user and determines a range of the first communication data to be associated with the second communication data on the basis of the instruction signal.

10. The data association system according to claim 1, wherein
the first communication data is voice data exchanged during the communication performed by the communication terminal, and
the association unit detects a silent pause in the first communication data and determines a range of the first communication data to be associated with the second communication data relative to the silent pause.

11. A data association method performed by a computer, comprising:
recording, performed by a communication monitoring unit included in the computer, in a recording unit included in the computer, communication status data containing data indicating a communication status of communication performed by a communication terminal and data for specifying at least one of both users in the communication;
acquiring, performed by a communication data acquiring unit included in the computer, first communication data that the communication terminal exchanges during the communication indicated by the communication status data and recording the first communication data in the recording unit in a state where the first communication data is associated with the communication status data of the communication;
making, performed by a data communication unit included in the computer, second communication data accessible to the both users through communication different from the communication of the first communication data; and
specifying, performed by an association unit included in the computer, among in-progress communications indicated by the communication status data, communication held by the same users as the both users in the communication of the second communication data and making the first communication data recorded in a state of being associated with the specified communication data accessible to the both users by associating the first communication data with the second communication data.

12. A computer readable recording medium recording a data association program causing a computer to execute a data association operation, the computer executing:
a communication monitoring process in which communication status data containing data indicating a communication status of communication performed by a communication terminal and data for specifying at least one of both users in the communication is recorded in a recording unit;
a communication data acquiring process in which first communication data that the communication terminal exchanges during the communication indicated by the communication status data is acquired and the first communication data is recorded in the recording unit in a state where the first communication data is associated with the communication status data of the communication;
a data communication process in which second communication data is made accessible to the both users through communication different from the communication of the first communication data; and
an association process in which, among in-progress communications indicated by the communication status data, communication held by the same users as the both users in the communication of the second communication data is specified and the first communication data recorded in a state of being associated with the specified communication data is made accessible to the both users by being associated with the second communication data.
